(19) United States
(12) Patent Application Publication
(10) Pub. No.: US 2008/0103942 A1
(43) Pub. Date: May 1, 2008

(54) INVENTORY MANAGEMENT SYSTEM

(76) Inventor: JO L. SHERNAMAN, COLUMBIA, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/851,368

(22) Filed: Sep. 6, 2007

Related U.S. Application Data
(60) Provisional application No. 60/824,770, filed on Sep. 6, 2006.

(51) Int. Cl. G06Q 10/00

(52) U.S. Cl. 705/28

(57) ABSTRACT

A web-based system for managing assets is provided. The system of the instant invention allows retail dealers and distributors to manage their inventory of items for sale with functionality that seamlessly and naturally links to functionality that satisfies floor plan lenders' interests in asset or collateral management in such a way that, simply by using dealership inventory management functionality the floor plan lenders, without the need for a physical inventory, the lenders can be assured that their floor plan borrowers cannot sell “out of trust.”

### CROSS-REFERENCE TO RELATED APPLICATIONS

This application claims priority pursuant to 35 U.S.C. 119(e) to co-pending U.S. Provisional Patent Application Ser. No. 60/824,770, filed Sep. 6, 2006, the entire disclosure of which is incorporated herein by reference.

### FIELD OF THE INVENTION

The present invention relates generally to a system for managing inventory. More particularly, the present invention relates to a web-based system for managing assets such that retail dealers and distributors can manage their inventory of items for sale with functionality that seamlessly and naturally links to functionality that satisfies floor plan lenders' interests in asset or collateral management in such a way that, simply by using dealership inventory management functionality the floor plan lenders, without the need for a physical inventory, can be assured that their floor plan borrowers cannot sell “out of trust.”

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a screen shot of a home page of an exemplary embodiment of the instant invention.

FIG. 2 shows a search and results screen for a Major Unit Inventory (MUI) module of the system shown in FIG. 1.

FIG. 3 shows a MUI detail screen pop-up.

FIG. 4 shows a screen shot of a module of the instant invention that projects future sales.

FIG. 5 is a more detailed screen shot of the screen shown in FIG. 4.

FIG. 6 is a screen shot of a Bank Reconciliation program of the instant invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

A preferred embodiment of the instant is described herein in the context of a web-based system for managing assets of retail dealers and/or distributors. In the preferred embodiment described herein, the web-based system of the instant invention is utilized for managing assets of a motorcycle dealer, in which the managed assets are motorcycle units. The retail dealers and/or distributors access the website of the instant invention and input data regarding motorcycle units in the dealers'/distributors' inventory. When status of the unit changes (i.e. a new unit is ordered, shipped, received, assembled, sold, etc.), the dealer/distributor updates such information on the website. Floor plan lenders of the dealers and/or distributors are allowed access to certain portions of the inventive website so as to be able to obtain current and accurate information regarding the status (i.e. location, whether sold, ready for sale, etc.) of units (i.e. motorcycles) for which the lender has provided financing to the dealer/distributor.

The website may be an independent website operated by the dealer/distributor or lender, or alternatively, in the preferred embodiment, the website is a webpage (or series of webpages) dedicated to a dealer/distributor (or lender) that is part of a central website operated by an independent third party. In the preferred embodiment, the independent third party operates the central website and database for multiple dealers/distributors (or lenders) that are using the system of the instant invention. Data regarding the motorcycles (i.e. location, whether sold, ready for sale, etc.) is stored in the database of the website for access by the dealer/distributor and/or the lender of the dealer/distributor.

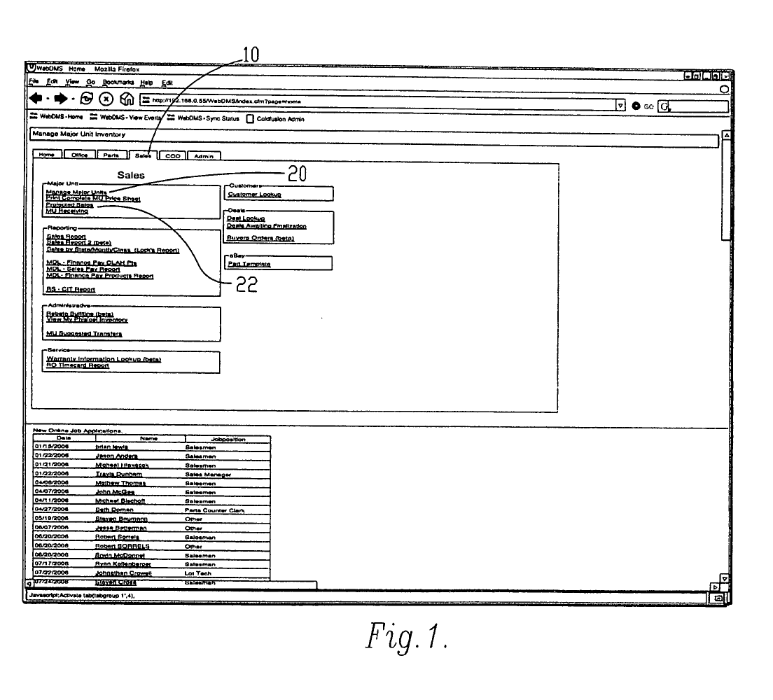

Referring to FIG. 1, a screen shot of a home page of an exemplary embodiment of the instant invention is shown. As shown in FIG. 1, the user (dealer/distributor or lender) that accesses the website of the instant invention is provided various options for accessing information stored in the website database about a motorcycle dealership and motorcycle units located in inventory of the motorcycle dealership. The desired type of information to be accessed is quickly and easily obtained by selecting the active links and/or page tabs shown in FIG. 1. For example, the screen shot depicted in FIG. 1 shows “Sales” tab 20 selected to allow the user to access various types of information regarding motorcycle units that have been sold, or that are intended to be sold by a particular dealership that has stored information in the database of the inventive website. The user is then allowed to select the detailed type of information desired to be reviewed about sales of motorcycle units in the dealership by selecting one of a number of active links (shown in FIG. 1 as underlined text) on the web page. For example, the user may select the Manage Major Units link 20 to access a Major Unit Inventory (MUI) module of the inventive website.

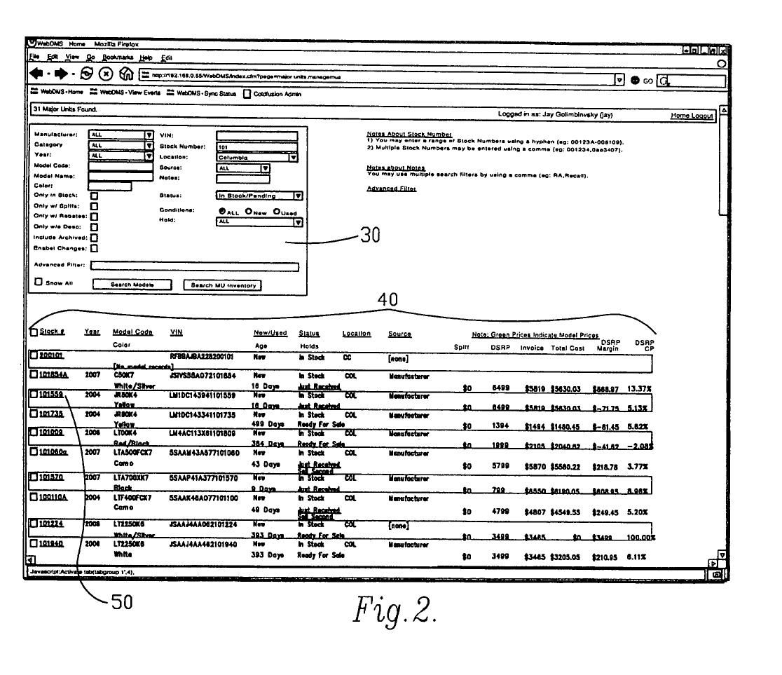

FIG. 2 shows a search and results screen for the Major Unit Inventory module of the system shown in FIG. 1 that is displayed after the user has selected the Manage Major Units link 20. The search engine of the instant invention allows very detailed searches and blanket changes to be made. For example, the user of the instant website selects various search criteria on search form 30 to obtain the specific information desired. The user is allowed to search for motorcycle units based upon criteria including but not limited to the manufacturer of the motorcycle, category (such as street/road bike, dirt bike, etc.), year, model code, model name, color, VIN, dealer stock number, physical location of the motorcycle (such as the specific dealership in which the motorcycle unit is located), source (manufacturer, trade, etc.), notes, whether the unit is in stock, has spiffs, rebates, status (i.e. in stock, ready for sale, just received, sell second, etc.), condition (new, used, etc.), holds (i.e. reasons why the unit may not be available for immediate sale), and the like. Once search results 40 are obtained, the user may sort results by each category of information displayed such as by stock number, year, model code, color, VIN, condition (new/used), age (number of days in inventory), status, location, source, holds (i.e. whether ready for sale, in stock, just received, etc.), location, source, spiff amount, DSRP (suggested retail price), invoice amount, total cost to dealer, DSRP Margin (based upon difference between DSRP and total cost), DSRP GP (percentage of DSRP Margin to DSRP). In the preferred embodiment (model prices, or DSRP and amounts based upon DSRP such as DSRP Margin and DSRP GP are shown is a unique color to allow that information to stand out from the rest of the information shown on the screen.

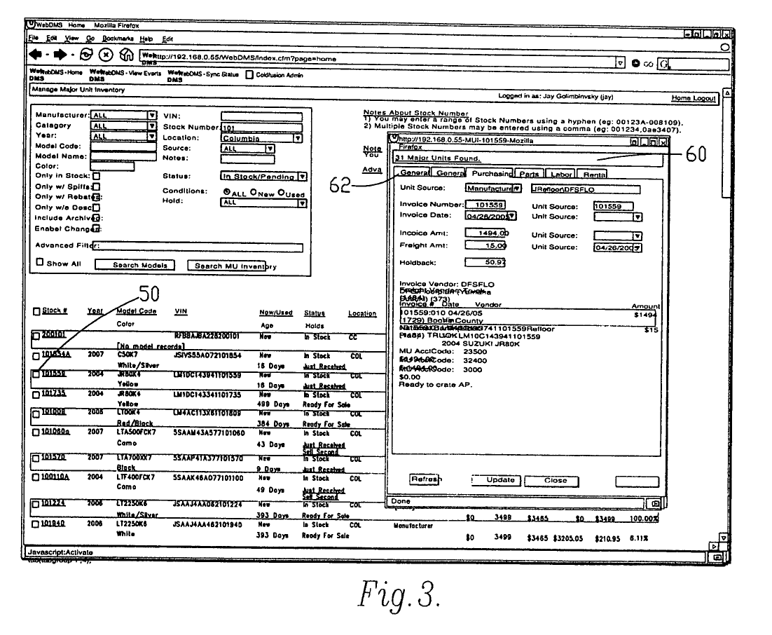

FIG. 3 shows a MUI detail screen, showing details in a separate pop-up screen for a specific unit (motorcycle) selected from the list of units shown in the search results of FIG. 2. In FIG. 3 the user has selected the active link 50 (shown in FIGS. 2 and 3) to obtain more detailed information regarding the specific motorcycle represented by that link. The more detailed information is shown in pop-up screen 60, which includes multiple page tabs 62 that may be accessed by the user depending upon the specific detailed information desired. For example, as shown in FIG. 3, the purchasing page tab has been selected to allow the user to see information relating to the purchase of the specific motorcycle unit, such as invoice price, date of invoice, date the unit was received, freight amount, holdback amount, etc. Other information tabs include general information regarding the motorcycle unit, detailed pricing information, parts information, labor and retail information.

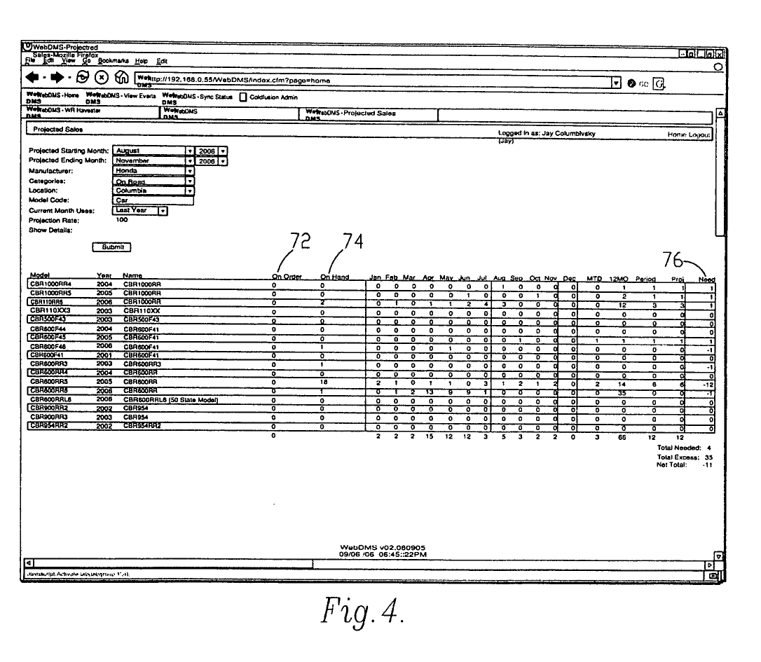

FIG. 4 shows a screen shot of a module that projects future sales for a motorcycle dealership/distributor. The module is accessed by the user by selecting active link 22 on the home page shown in FIG. 1. The projected sales module of the instant invention determines the projected sales by utilizing information about motorcycle units that have been entered into the database for a particular dealership/distributor. The information utilized includes previous sales, expected growth, units that are on order, units on hand and seasonal trends for a particular model of motorcycle. Information such as expected growth and seasonal trends can be programmed into the computer program of the instant invention, or alternatively in a preferred embodiment such information is based upon historical data regarding the particular dealership that is stored in the database of the instant invention. Based upon the determination made by the computer program of the instant invention regarding projected sales during a selected time period, as well as the number of units of a particular model on hand (shown in column 72), and the number of units for a particular model on order (shown in column 74), the computer program provides in column 76 a recommendation as the amount of additional units that should be ordered. For example, if the program determines that 4 units of a particular model of motorcycle will be sold over the selected time period, and 2 units are currently in stock and 1 additional unit is on order, the program will recommend in column 76 that one additional unit will be necessary during the selected time period.

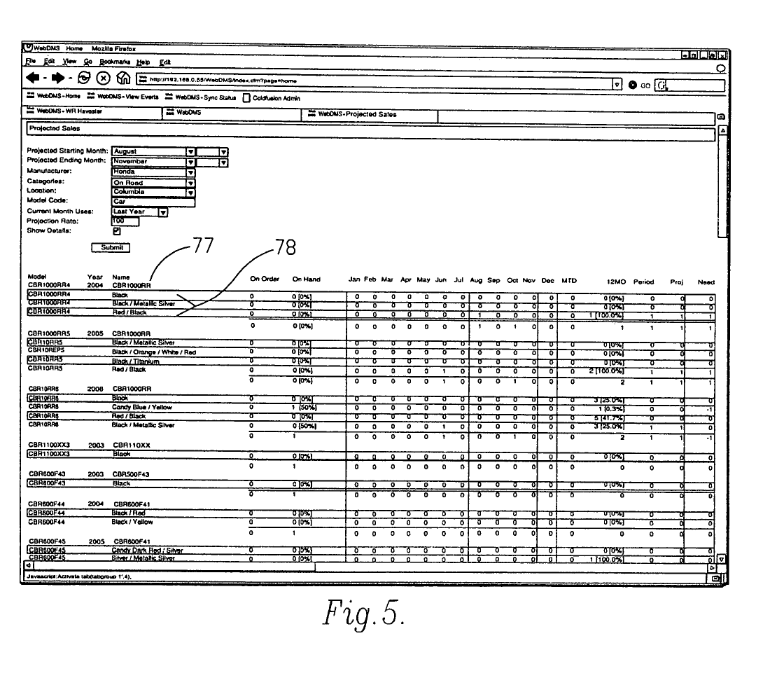

FIG. 5 is a more detailed screen shot of the screen shown in FIG. 4 showing a breakdown of projected sales and units needed based upon model and more specifically based upon color for each model. For example, item 77 shows projections for model CBR1000RR motorcycles, and items 78 show the color options black, black/metallic silver, and red/black.

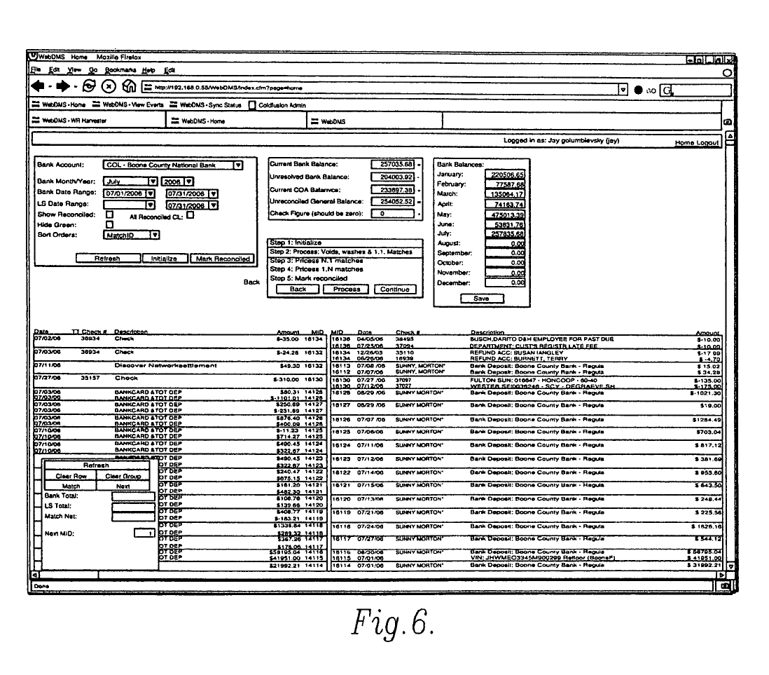

FIG. 6 is a screen shot of a Bank Reconciliation program that allows the user to reconcile dealership account data with financial data (such as deposits and withdrawals) received electronically from the dealerships bank. Account information for a dealership is downloaded into the database of the instant invention. The computer program of the instant invention compares the information downloaded from the bank to information entered by the dealership into the database. For example, if a dealership receives a check from a purchaser of a motorcycle, the amount of the check is input into the database, including information such as date of the check, description (i.e. check, credit card payment, etc.), check number, etc. If information downloaded from the bank does not reconcile with information entered into the database at the dealership, the system of the instant invention provides warnings to the user (such as by color code for a line item, or audio or other visual warnings).

The above described invention provides a web-based system for managing assets such that retail dealers and distributors can manage their inventory of items for sale with functionality that seamlessly and naturally links to functionality that satisfies floor plan lenders' interests in asset or collateral management in such a way that, simply by using dealership inventory management functionality the floor plan lenders, without the need for a physical inventory, can be assured that their floor plan borrowers cannot sell “out of trust.”

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of managing inventory comprising:
providing a dealer/distributor access to a web-based system for storing information regarding inventory;
storing detailed information regarding said dealer/distributor's inventory on said web-based system; and
allowing a lender to said dealer/distributor access to said web-based system to obtain information regarding status of said inventory.

2. The method as claimed in claim 1 further comprising the step of updating changing status information of said inventory on said web-based system by said dealer/distributor.
